(19) United States
(12) Patent Application Publication
(10) Pub. No.: US 2026/0136359 A1
(43) Pub. Date: May 14, 2026

(54) METHOD AND DEVICE FOR INDICATING UPLINK DEMODULATION REFERENCE SIGNAL PORT, AND STORAGE MEDIUM

(71) Applicant: Beijing Xiaomi Mobile Software Co., Ltd., Beijing (CN)

(72) Inventor: Xueyuan GAO, Beijing (CN)

(21) Appl. No.: 19/115,652

(22) PCT Filed: Sep. 28, 2022
(86) PCT No.: PCT/CN2022/122318

§ 371 Date: Mar. 26, 2025

(51) Int. Cl. H04W 72/1268; H04L 5/00; H04W 72/232

(52) U.S. Cl. CPC H04W 72/1268; H04L 5/0051; H04W 72/232

(57) ABSTRACT

A method for indicating an uplink demodulation reference signal (DMRS) port, including: sending first indication information in a case where a terminal performs single downlink control information (S-DCI) based simultaneous transmission via multi-panel (STxMP) of a physical uplink shared channel (PUSCH) in a space division multiplexing (SDM) manner, where an indication field of an antenna port DMRS in DCI is configured to indicate a total number of all allocated DMRS ports, where the first indication information is configured to indicate a DMRS port that is respectively allocated when a transport block of the PUSCH is sent over a same time-frequency resource towards a different transmission and reception point (TRP) via a different panel; where a different TRP/panel/transmission configuration indicator (TCI)/transmission occasion (TO) is respectively associated with a different beam/TCI, and a correspondence relationship exists between the DMRS port and the panel.

### CROSS-REFERENCE TO RELATED APPLICATIONS

The present application is a U.S. National Stage of International Application No. PCT/CN2022/122318, filed on Sep. 28, 2022, the contents of all of which are incorporated herein by reference in their entireties for all purposes.

### BACKGROUND OF THE INVENTION

In a multi-transmission and reception point (multi-TRP) scenario, uplink enhancement supports a repeated sending manner of a physical uplink shared channel (PUSCH)/physical uplink control channel (PUCCH) by using a time division multiplexing (TDM) manner to send uplink channels to different transmission and reception points (TRPs) in different uplink beam directions.

### SUMMARY OF THE INVENTION

The present disclosure relates to the technical field of communications, and provides a method and device for indicating an uplink demodulation reference signal (DMRS) port, and a storage medium.

According to a first aspect of embodiments of the present disclosure, a method for indicating an uplink demodulation reference signal (DMRS) port is provided. The method is performed by a network device and includes:
sending first indication information, in a case where a terminal performs single downlink control information (S-DCI) based simultaneous transmission via multi-panel (STxMP) of a physical uplink shared channel (PUSCH) in a space division multiplexing (SDM) manner;
where an indication field of an antenna port DMRS in DCI is configured to indicate a total number of all allocated DMRS ports for the terminal; where the first indication information is configured to indicate a DMRS port that is respectively allocated when a transport block of the PUSCH is sent over a same time-frequency resource towards a different transmission and reception point (TRP) via a different panel; where a different TRP/panel/transmission configuration indications (TCI)/transmission occasion (TO) is respectively associated with a different beam/TCI, and a correspondence relationship exists between the DMRS port and a panel.

According to a second aspect of embodiments of the present disclosure, a method for indicating an uplink demodulation reference signal (DMRS) port is provided. The method is performed by a terminal and includes:
receiving first indication information, in a case where the terminal performs single downlink control information (S-DCI) based simultaneous transmission via multi-panel (STxMP) of a physical uplink shared channel (PUSCH) in a space division multiplexing (SDM) manner,
where an indication field of an antenna port DMRS in DCI is configured to indicate a total number of all allocated DMRS ports for the terminal; where the first indication information is configured to indicate a DMRS port that is respectively allocated when a transport block of the PUSCH is sent over a same time-frequency resource towards a different transmission and reception point (TRP) via a different panel, where a different TRP/panel/transmission configuration indication (TCI)/transmission occasion (TO) is respectively associated with a different beam/TCI, and a correspondence relationship exists between the DMRS port and a panel.

According to a third aspect of embodiments of the present disclosure, a device for indicating an uplink demodulation reference signal (DMRS) port is provided. The device includes: one or more processors; and a memory that stores processor-executable instructions; where the one or more processors are collectively configured to perform the method described in the above first aspect and one implementation of the first aspect.

According to a fourth aspect of embodiments of the present disclosure, a device for indicating an uplink demodulation reference signal (DMRS) port is provided. The device includes: one or more processors; and a memory that stores processor-executable instructions; where the one or more processors are collectively configured to:
receive first indication information, in a case where the terminal performs single downlink control information (S-DCI) based simultaneous transmission via multi-panel (STxMP) of a physical uplink shared channel (PUSCH) in a space division multiplexing (SDM) manner,
where an indication field of an antenna port DMRS in DCI is configured to indicate a total number of all allocated DMRS ports for the terminal;
where the first indication information is configured to indicate a DMRS port that is respectively allocated when a transport block of the PUSCH is sent over a same time-frequency resource towards a different transmission and reception point (TRP) via a different panel;
where a different TRP/panel/transmission configuration indication (TCI)/transmission occasion (TO) is respectively associated with a different beam/TCI, and a correspondence relationship exists between the DMRS port and a panel.

It is to be understood that the above general description and the following detailed description are merely for example and explanatory, and cannot limit the present disclosure.

### BRIEF DESCRIPTION OF DRAWINGS

Accompanying drawings here, which are incorporated in and constitute a part of this specification, illustrate embodiments consistent with the present disclosure and together with the specification, serve to explain the principles of the present disclosure.

FIG. 1 is a schematic diagram of a wireless communication system shown according to an example.

FIG. 2A, FIG. 2B, FIG. 2C and FIG. 2D are schematic structural diagrams of a DMRS shown according to an example.

FIG. 3 is a logic diagram of multi-panel sending of S-DCI shown according to an example.

FIG. 4 is a flowchart of a method for indicating an uplink DMRS port shown according to an example.

FIG. 5 is a flowchart of a method for indicating an uplink DMRS port shown according to an example.

FIG. 6 is a block diagram of a device for indicating an uplink DMRS port shown according to an example.

FIG. 7 is a block diagram of a device for indicating an uplink DMRS port shown according to an example.

FIG. 8 is a block diagram of a device for indicating an uplink DMRS port shown according to an example.

FIG. 9 is a block diagram of a device for indicating an uplink DMRS port shown according to an example.

### DETAILED DESCRIPTION OF THE INVENTION

Examples will be illustrated in detail here, and instances of which are represented in the accompanying drawings. When the following descriptions refer to the accompanying drawings, the same number in the different accompanying drawings represents the same or similar elements unless otherwise indicated. The implementations described in the following examples do not represent all implementations consistent with the present disclosure.

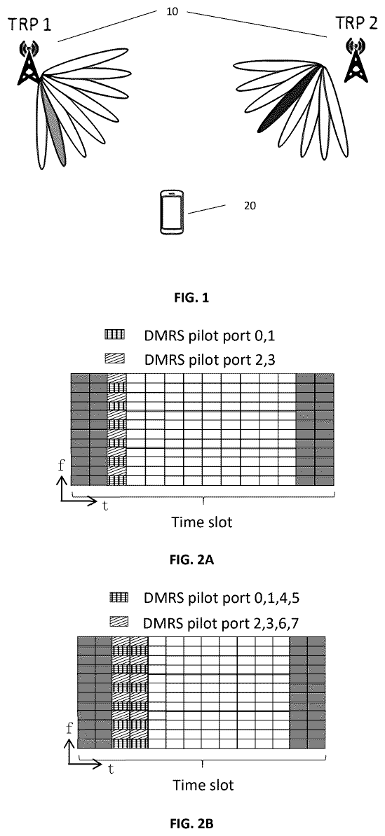

A method for indicating an uplink DMRS port provided by an embodiment of the present disclosure may be performed by a wireless communication system shown in FIG. 1. Referring to FIG. 1, the wireless communication system includes a network device 10 and a terminal 20. The terminal 20 is connected with the network device 10 through a wireless resource, and performs data transmission.

It may be understood that the wireless communication system shown in FIG. 1 is merely a schematic illustration, and the wireless communication system may further include other network devices, for example, may further include a core network device, a wireless relay device, a wireless backhaul device, etc., which is not drawn in FIG. 1. The embodiment of the present disclosure does not limit the number of the network devices and the number of the terminals included in the wireless communication system.

It may be further understood that the wireless communication system according to the embodiment of the present disclosure is a network providing a wireless communication function. The wireless communication systems may employ different communication technologies, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (single Carrier FDMA, SC-FDMA), and carrier sense multiple access with collision avoidance. A network may be divided into a 2G (generation) network, a 3G network, a 4G network or a future evolution network, such as a 5G network according to capacity, speed, delay and other factors of the different networks. The 5G network may also be referred to as a new radio (NR) network. For convenience of description, the wireless communication network may be referred to as the network for short sometimes in the present disclosure.

Further, the network device 10 involved in the present disclosure may also be referred to as a radio access network device. The radio access network device may be: a base station, an evolved node B (base station), a femto, an access point (AP) in a wireless fidelity (WIFI) system, a wireless relay node, a wireless backhaul node, a transmission point (TP) or a transmission and reception point (TRP), etc., such as TRP1 and TRP2 as shown in FIG. 1. The radio access network device may further be a gNB in an NR system, or may further be a component or part of a device that constitutes a base station. It is to be understood that a specific technology and a specific device form employed by the network device 10 are not limited in the embodiment of the present disclosure. In the present disclosure, the network device 10 may provide communication coverage for a specific geographic region, and may communicate with a terminal 20 located within a coverage region (a cell). In addition, when it is a vehicle-to-everything (V2X) communication system, the network device 10 may also be an on-board device.

Further, the terminal 20 involved in the present disclosure may also be referred to as a terminal device, user equipment (UE), a mobile station (MS), a mobile terminal (MT), etc., and is a device that provides voice and/or data connectivity to a user. For example, the terminal 20 may be a handheld device or an on-board device with a wireless connection function. At present, some examples of the terminal 20 are: a mobile phone, customer premise equipment (CPE), a pocket personal computer (PPC), a palm computer, a personal digital assistant (PDA), a notebook computer, a tablet computer, a wearable device, or the on-board device, etc. In addition, when it is a vehicle-to-everything (V2X) communication system, the terminal device may further be the on-board device. It is to be understood that the specific technology and the specific device form employed by the terminal 20 are not limited in the embodiment of the present disclosure.

In a multi-transmission and reception point (multi-TRP) scenario, uplink enhancement supports a repeated sending manner of a physical uplink shared channel (PUSCH)/physical uplink control channel (PUCCH) by using a time division multiplexing (TDM) manner to send uplink channels to different transmission and reception points (TRPs) in different uplink beam directions. At present, the bottleneck of a communication system still lies in a rate and coverage of uplink transmission. Thus, for a system enhancement direction of an R18 standard, the main consideration is to perform simultaneous transmission via a multi-panel terminal in the multi-TRP (also referred to as mTRP or M-TRP) scenario to increase an uplink speed, and further improve transmission reliability.

In new radio (NR), in order to enhance signal coverage and improve signal quality, a phase tracking reference signal (PT-RS) is configured as a UE-specific reference signal by a network to a terminal, and the PT-RS is configured to track phase noise introduced by a local oscillator in a network device and the terminal, and is configured to estimate a common phase error (CPE). The PT-RS may be regarded as an extension of a demodulation reference signal (DMRS) and has a close relationship, such as using of the same precoder, port correlation, generation of an orthogonal sequence, and a quasi co-location (QCL) relationship.

In uplink enhancement, in order to support a simultaneous transmission via multi-panel (STxMP) scheme based on single downlink control information (S-DCI, also referred to as single DCI), an enhancement scheme that can support flexible allocation indication of DMRS ports for SU-MIMO and MU-MIMO needs to be considered under a transmission multiplexing scheme of a space division multiplexing (SDM).

In the related art, in a case where the network device (such as a base station) has a plurality of TRPs, an M-TRP/multi-panel can be used to provide services to the terminal, and a COMP technology is introduced, so that the network device can provide more balanced service quality within a service area.

Unlike single point transmission such as a single TRP or panel, coordinated multi-point (COMP) transmission refers to multiple TRPs (Muplti-TRP, mTRP)/panels providing data services to one user. An antenna array of each TRP may be divided into several relatively-independent antenna panels, so the shape and number of ports of the entire array can be flexibly adjusted according to deployment scenarios and service demands. The antenna panels or the TRPs may also be connected by optical fibers for more flexible distributed deployment. In a millimeter wave band, as the wavelength decreases, a blocking effect caused by obstacles such as human bodies or vehicles will become more significant. In this case, from the perspective of ensuring robustness of a link connection, coordination between the multiple TRPs or panels can be utilized for transmission/reception from a plurality of beams at multiple angles, so as to reduce the adverse effect caused by the blocking effect. In one implementation, a correspondence relationship exists among the panel, the TRP, a transmission configuration indication (TCI), and a transmission occasion (TO), so the TRP/panel/TCI/TO or multi-TRP/panel/TCI/TO is used in the present disclosure for presentation. In all embodiments the present disclosure, “/” represents “or”.

A plurality of sites involved in a COMP transmission process may correspond to a plurality of geographically different sites or a plurality of sectors with different antenna panel orientations. For example, in a case where the terminal receives data from different sites, the spatial differences between all the sites can lead to differences in large-scale channel parameters of receiving links from the different sites, such as Doppler frequency offset and delay spread. The large-scale parameters of the channel will directly affect adjustment and optimization of a filter coefficient during channel estimation. Corresponding to signals emitted by the different sites, different channel estimation filter parameters are to be used to adapt to the corresponding channel transmission characteristics.

Thus, although the differences in the spatial location or angle among the different sites are transparent to UE and CoMP operations themselves, the impact of the above spatial differences on the large-scale parameters of the channel is an important factor that the UE needs to consider when performing channel estimation and reception detection. Thus, QUASI-CO-LOCATION (QCL) is introduced in the related art. QCL means that the large-scale parameters of the channel experienced by a symbol on a certain antenna port may be inferred from the channel experienced by a symbol on another antenna port. The large-scale parameters may include delay spread, average delay, Doppler spread, Doppler shift, average gain, and spatial reception parameters.

The so-called QCL of two antenna ports under certain large-scale parameter meanings refers to the fact that these large-scale parameters of these two ports are the same. Or in other words, as long as certain large-scale parameters of the two ports are consistent, regardless of whether there is a difference between their actual physical locations or corresponding antenna panel orientations, the terminal may consider that these two ports originate from the same location (i.e., quasi-co-location).

For some typical application scenarios, considering a possible QCL relationship between various reference signals, from the perspective of simplifying signaling, NR divides several large-scale channel parameters into the following four types for the system to configure/indicate according to different scenarios:
QCL-TypeA: {Doppler frequency shift, Doppler spread, average delay, delay spread}
Except for the spatial reception parameter, all other large-scale parameters are the same.
For frequency bands below 6 GHZ, the spatial reception parameters may not be needed.
QCL-TypeB: {Doppler frequency shift, Doppler spread}
Merely for 6 GHZ
QCL-TypeC: {Doppler frequency shift, average delay}.
QCL-TypeD: {Spatial reception parameter}

As previously mentioned, since this parameter mainly targets frequency bands above 6 GHz, it is treated as a separate QCL type.

The application of the multi-TRP/panel/TCI/TO mainly aims at improving coverage at an edge of a cell, providing more balanced service quality within the service area, and collaboratively transmitting data between the multi-TRP/panel/TCI/TO in different ways. Considering from the perspective of a network form, deploying a network with a large number of distributed access points and centralized baseband processing is more conducive to providing a balanced user experience rate and significantly reducing latency and signaling overheads caused by handover. By utilizing coordination between the multiple TRPs or panels for channel transmission/reception from the plurality of beams at multiple angles, various occlusion/blocking effects can be better overcome, the robustness of the link connection can be ensured, and it is suitable for a URLLC service to improve transmission quality and meet reliability demands.

In an R16 research phase, transmission enhancement of the PDSCH is performed based on the application of a coordinated multi-point transmission technology between downlink multi-TRP (transmitting and receiving points)/antenna panels. Because a data transmission packet includes scheduling feedback of uplink and downlink channels, in URLLC research, merely enhancing a downlink data channel cannot guarantee overall service performance. Thus, in the research of R17, the PDCCH, as well as the PUCCH and the PUSCH continue to be enhanced.

PUSCH uplink transmission may be enhanced between the network device and the terminal based on the multi-TRP/panel/TCI/TO. Specifically, an uplink transmission scheme of the PUSCH includes a codebook-based uplink transmission scheme and a non-codebook-based uplink transmission scheme.

In the related art, for the PDSCH/PUSCH, a data layer for data transmission corresponds to a DMRS port used for demodulation. The design of a data channel (PDSCH/PUSCH) DMRS in the NR system mainly includes a front-load DMRS and an additional DMRS.

For the front-load DMRS, a location where the DMRS first appears within each scheduling time unit should be as close as possible to a starting point of the scheduling. The use of the front-load DMRS helps a receiving side to quickly estimate the channel and perform reception detection, which plays an important role in reducing delay and supporting the so-called self-contained structure. Depending on a total number of orthogonal DMRS ports, the front-load DMRS may occupy up to two consecutive orthogonal frequency division multiplexing (OFDM) symbols.

The design concept of the front-load DMRS is divided into two types, with the type 1 using a COMB+OCC structure and the type 2 using an FDM+OCC structure.

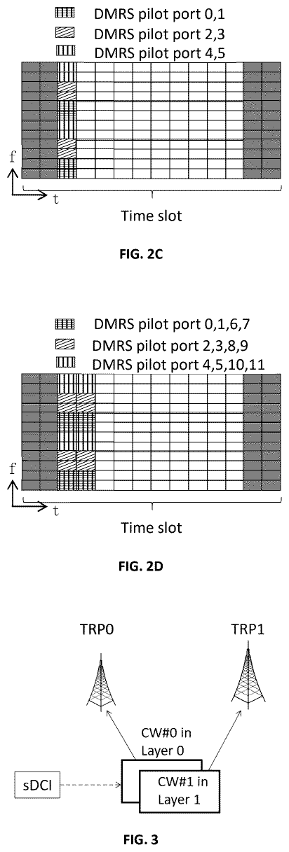

FIG. 2A to FIG. 2D show schematic diagrams of pattern design of two configuration types of the front-load DMRS. FIG. 2A and FIG. 2B show schematic diagrams of DMRS pattern mapping for one OFDM symbol and two OFDM symbols corresponding to a configuration type 1. FIG. 2C and FIG. 2D show schematic diagrams of DMRS pattern mapping for one OFDM symbol and two OFDM symbols corresponding to a configuration type 2.

The number of DMRS ports depends on the number of orthogonal ports used for transmission, and the front-load DMRS may be configured with a maximum of two OFDM symbols. Considering the factor of power utilization efficiency, in a case where the front-load DMRS with the two symbols is used, a TD-OCC is used in a time domain based on a cyclic shift (CS) or an orthogonal cover codes (OCC) in a frequency domain.

For a low-mobility scenario, the front-load DMRS can achieve channel estimation performance that meets demodulation demands with lower overhead. However, the NR system considers a maximum mobile speed of up to 500 km/h. Faced with mobility with such a large dynamic range, in addition to the front-load DMRS, in a medium/high-speed scenario, more DMRS symbols need to be inserted within a scheduling duration to meet estimation accuracy of channel time-variation. The NR system adopts a DMRS structure that combines the front-load DMRS with an additional DMRS with configurable time-domain density. The pattern of each group of additional DMRS is a repetition of the front-load DMRS. Thus, consistent with the front-load DMRS, each group of additional DMRS may also occupy up to two consecutive DMRS symbols. According to a specific usage scenario, up to three groups of additional DMRS may be configured in each scheduling. The number of the additional DMRS depends on the high-level parameter configuration and specific scheduling duration.

In the relevant protocol, a DMRS port allocation method with different parameter configurations under an uplink cyclic prefix orthogonal frequency-division multiplexing (CP-OFDM) waveform is provided.

The following table shows the allocation of the DMRS ports with different parameter configurations. In the following table, Value represents a codepoint, Number of DMRS CDM group(s) without data represents a number of DMRS CDM group(s) without data transmission, DMRS port represents the port of DMRS, and Number of front-load symbols represents a number of front-load symbols.

TABLE 1

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 1 represents antenna port(s), a transform precoder is disabled, dmrs-Type=1 (DMRS type), maxLength (maximum length)=1, RANK (a number of transmission layers)=1, which indicates the allocation of DMRS ports in a case of DMRS Type 1, single symbol, and single stream transmission.

TABLE 2

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 2 | 0, 2 |
| 4-7 | Reserved | Reserved |

Table 2 represents antenna port(s), a transform precoder is disabled, dmrs-Type=1 (DMRS type), maxLength (maximum length)=1, RANK (the number of transmission layers)=2, which indicates the allocation of DMRS ports in a case of DMRS Type 1, single symbol, and double-layer transmission.

TABLE 3

| Value | Number of DMRS CDM group(s) without data | DMRS port(s) |
|---|---|---|
| 0 | 2 | 0-2 |
| 2-7 | Reserved | Reserved |

Table 3 represents antenna port(s), a transform precoder is disabled, dmrs-Type=1 (DMRS type), maxLength (maximum length)=1, RANK (the number of transmission layers)=3, which indicates the allocation of DMRS ports in a case of DMRS Type 1, single symbol, and three-layer transmission.

TABLE 4

| Value | Number of DMRS CDM group(s) without data | DMRS port(s) |
|---|---|---|
| 0 | 2 | 0-3 |
| 2-7 | Reserved | Reserved |

Table 4 represents antenna port(s), a transform precoder is disabled, dmrs-Type=1 (DMRS type), maxLength (maximum length)=1, RANK (the number of transmission layers)=4, which indicates the allocation of DMRS ports in a case of DMRS Type 1, single symbol, and four-layer transmission.

TABLE 5

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Table 5 represents antenna port(s), a transform precoder is disabled, dmrs-Type=1 (DMRS type), maxLength (maximum length)=2, RANK (the number of transmission layers)=1, which indicates the allocation of DMRS ports in a case of DMRS Type 1, two symbols, and single stream transmission.

TABLE 6

| | | | Number of |
|---|---|---|---|
| | Number of DMRS CDM | DMRS | front-load |
| Value | group(s) without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Table 6 represents antenna port(s), a transform precoder is disabled, dmrs-Type=1 (DMRS type), maxLength (maximum length)=2, RANK (the number of transmission layers)=2, which indicates the allocation of DMRS ports in a case of DMRS Type 1, two symbols, and two-layer transmission.

TABLE 7

| | | | Number of |
|---|---|---|---|
| | Number of DMRS CDM | DMRS | front-load |
| Value | group(s) without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Table 7 represents antenna port(s), a transform precoder is disabled, dmrs-Type=1 (DMRS type), maxLength (maximum length)=2, RANK (the number of transmission layers)=3, which indicates the allocation of DMRS ports in a case of DMRS Type 1, two symbols, and three-layer transmission.

TABLE 8

| | | | Number of |
|---|---|---|---|
| | Number of DMRS CDM | DMRS | front-load |
| Value | group(s) without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Table 8 represents antenna port(s), a transform precoder is disabled, dmrs-Type=1 (DMRS type), maxLength (maximum length)=2, RANK (the number of transmission layers)=2, which indicates the allocation of DMRS ports in a case of DMRS Type 1, two symbols, and four-layer transmission.

TABLE 9

| | Number of DMRS CDM | |
|---|---|---|
| Value | group(s) without data | DMRS port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Table 9 represents antenna port(s), a transform precoder is disabled, dmrs-Type=2 (DMRS type), maxLength (maximum length)=1, RANK (the number of transmission layers)=1, which indicates the allocation of DMRS ports in a case of DMRS Type 2, single symbol, and single-layer transmission.

TABLE 10

| | Number of DMRS CDM | |
|---|---|---|
| Value | group(s) without data | DMRS port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Table 10 represents antenna port(s), a transform precoder is disabled, dmrs-Type=2 (DMRS type), maxLength (maximum length)=1, RANK (the number of transmission layers)=2, which indicates the allocation of DMRS ports in a case of DMRS Type 2, single symbol, and two-layer transmission.

TABLE 11

| | Number of DMRS CDM | |
|---|---|---|
| Value | group(s) without data | DMRS port(s) |
| 0 | 2 | 0-2 |
| 1 | 3 | 0-2 |
| 2 | 3 | 3-5 |
| 3-15 | Reserved | Reserved |

Table 11 represents antenna port(s), a transform precoder is disabled, dmrs-Type=2 (DMRS type), maxLength (maximum length)=1, RANK (the number of transmission layers)=3, which indicates the allocation of DMRS ports in a case of DMRS Type 2, single symbol, and three-layer transmission.

TABLE 12

| | Number of DMRS CDM | |
|---|---|---|
| Value | group(s) without data | DMRS port(s) |
| 0 | 2 | 0-3 |
| 1 | 3 | 0-3 |
| 2-15 | Reserved | Reserved |

Table 12 represents antenna port(s), a transform precoder is disabled, dmrs-Type=2 (DMRS type), maxLength (maximum length)=1, RANK (the number of transmission layers)=4, which indicates the allocation of DMRS ports in a case of DMRS Type 2, single symbol, and four-layer transmission.

TABLE 13

| | | | Number of |
|---|---|---|---|
| | Number of DMRS CDM | DMRS | front-load |
| Value | group(s) without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Table 13 represents antenna port(s), a transform precoder is disabled, dmrs-Type=2 (DMRS type), maxLength (maximum length)=2, RANK (the number of transmission layers)=1, which indicates the allocation of DMRS ports in a case of DMRS Type 2, two symbols, and single transmission.

TABLE 14

| | | | Number of |
|---|---|---|---|
| | Number of DMRS CDM | DMRS | front-load |
| Value | group(s) without data | port(s) | symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Table 14 represents antenna port(s), a transform precoder is disabled, dmrs-Type=2 (DMRS type), maxLength (maximum length)=2, RANK (the number of transmission layers)=2, which indicates the allocation of DMRS ports in a case of DMRS Type 2, two symbols, and double-layer transmission.

TABLE 15

| | | | Number of |
|---|---|---|---|
| | Number of DMRS CDM | DMRS | front-load |
| Value | group(s) without data | port(s) | symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

Table 15 represents antenna port(s), a transform precoder is disabled, dmrs-Type=2 (DMRS type), maxLength (maximum length)=2, RANK (the number of transmission layers)=3, which indicates the allocation of DMRS ports in a case of DMRS Type 2, two symbols, and three-layer transmission.

TABLE 16

| | | | Number of |
|---|---|---|---|
| | Number of DMRS CDM | DMRS | front-load |
| Value | group(s) without data | port(s) | symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Table 16 represents antenna port(s), a transform precoder is disabled, dmrs-Type=2 (DMRS type), maxLength (maximum length)=2, RANK (the number of transmission layers)=4, which indicates the allocation of DMRS ports in a case of DMRS Type 2, two symbols, and four-layer transmission.

In the Multi-TRP scenario, the R17 standard supports a repeated sending manner of the PUSCH/PUCCH through uplink enhancement, in which the uplink channel can be sent to different TRPs in different uplink beam directions by using a time-division multiplexing (TDM) manner.

At present, the bottleneck of a communication system still lies in a rate and coverage of uplink transmission. Thus, for a system enhancement direction of the R18 standard, it is mainly considered that in the Multi-TRP scenario, the terminal performs simultaneous transmission via multi-TRP/panel/TCI/TO (STxMP) to increase an uplink rate, further improve transmission reliability, and perform multi-TRP based PUSCH enhancement. Multi-TRP based PUSCH enhancement may be scheduled based on one piece of downlink control information (DCI) carried by one physical downlink control channel (PDCCH), such as scheduling multi-TRP/panel/TCI transmission with single downlink control information (S-DCI). It is also possible to consider separate scheduling based on different pieces of DCI carried by different PDCCHs. FIG. 3 is a logic diagram of multi-panel sending implementation based on single DCI (S-DCI). As shown in FIG. 3, the terminal (UE) respectively transmits a PUSCH1 and a PUSCH2 towards a TRP1 and a TRP2 via a panel1 and a panel2 based on a transport layer1 and layer2.

The implementation of the terminal multi-panel generally involves configuring multiple physical panels, and capabilities of different panels may also vary. For example, with a different number of sounding reference signal (SRS) port, a maximum number of data transmission layers supported may not be the same. For example, one panel supports transmission of a maximum of 2 layers, and the other panel supports transmission of a maximum of 4 layers. A scheduler of the network device judges whether the terminal is currently suitable for uplink simultaneous transmission via multi-panel. In a case where the terminal is currently suitable for uplink simultaneous transmission via multi-panel and is scheduled simultaneously, the network device directly or indirectly indicates relevant transmission parameters, including specific beam indication information of the terminal, the number of data layers used for transmission, the allocation of DMRS ports used, and indication information of the precoder.

The method provided by the embodiment of the present disclosure is applicable to a DMRS port indication problem under S-DCI scheduling, that is, how to determine which DMRS ports to use for PUSCH sending on different panels.

At present, a maximum uplink number of transmission layers supported by the protocol is 4, corresponding to the transmission of one codeword. Thus, another issue in multi-panel enhancement is how to support 2 codewords in the uplink to achieve flexible mapping. In the related art, in a layer mapping solution for uplink or downlink, a case where the number of data layers is 2-4 corresponds to the transmission of one codeword (CW). However, this configuration makes it difficult for a same MCS to adapt to channel conditions in different layers, resulting in performance loss in a case of a significant performance difference in interlayer channels. Thus, it is considered that 2 CWs are also applied for scheduling and transmission for 2-4 layers or merely for 4 layers of data. FIG. 3 shows a schematic diagram of a layer mapping solution from codewords to layers. As shown in FIG. 3, in STxMP transmission under S-DCI scheduling, a codeword 0 is mapped to a layer 0 (CW #0 in Layer0), and a codeword 1 is mapped to a layer 1 (CW #1 in Layer1) for uplink transmission towards a TRP0 and a TRP1. In this way, the network device may perform full scheduling according to interlayer channel conditions. For example, for three-layer transmission, in the case of significant interlayer differences in channels, 2 CWs may be used for scheduling, with one CW transmitting layer1 data and the other CW transmitting layer2 data. This also facilitates data retransmission scheduling and helps improve system throughput. In the system, transmission of layer4 and below is dominant, so it is beneficial to optimizing overall performance.

For uplink synchronous transmission via multi-panel, cooperative transmission scheduling for one TB of the PUSCH based on S-DCI may support transmission schemes including one or more of a space division multiplexing (SDM) solution, a frequency division multiplexing (FDM) solution, and a single frequency network (SFN) solution.

The space division multiplexing (SDM) solution mainly involves a transport block (TB) of the PUSCH is respectively sent towards two different TRPs over a same time-frequency resource through a DMRS port or a port combination that is respectively allocated on a different panel, where a different TRP/panel/TCI/TO is respectively associated with a different TCI state (i.e., beam).

The space division multiplexing (SDM) scheme includes two schemes, SDM-A and SDM-B.

SDM-A: a different part of the TB of the PUSCH is respectively sent towards two different TRPs over the same time-frequency resource through the DMRS port or the port combination that is respectively allocated on the different panel, where the different TRP/panel/TCI/TO is respectively associated with the different TCI state (i.e., beam).

SDM-B: the repetition of a same TB corresponding to a different RV version of the PUSCH is respectively sent towards two different TRPs over the same time-frequency resource through the DMRS port or the port combination that is respectively allocated on the different panel, where the different TRP/panel/TCI/TO is respectively associated with the different TCI state (i.e., beam).

For the frequency division multiplexing (FDM) scheme, the TB of the PUSCH is respectively sent towards two different TRPs over a non-overlapping frequency-domain resource on the same time-domain resource through a same DMRS port or the port combination allocated on the different panel, where the different TRP/panel/TCI/TO is respectively associated with the different TCI state (i.e., beam).

The FDM has two possible schemes: FDM-A and FDM-B.

FDM-A: the different part of the TB of the PUSCH is respectively sent towards two different TRPs over the non-overlapping frequency-domain resource on the same time-domain resource through the same DMRS port or the port combination allocated on the different panel, where the different TRP/panel/TCI/TO is respectively associated with the different TCI state (i.e., beam).

FDM-B: the repetition of the same TB corresponding to the different RV version of the PUSCH is respectively sent towards two different TRPs over the non-overlapping frequency-domain resource on the same time-domain resource through the same DMRS port or the port combination allocated on the different panel, where the different TRP/panel/TCI/TO is respectively associated with the different TCI state (i.e., beam).

For the SFN scheme, the TB of the PUSCH is separately sent towards two different TRPs over the same time-frequency resource through the same DMRS port or the port combination allocated on the different panel, where the different TRP/panel/TCI/TO is respectively associated with the different TCI state (i.e., beam).

For simultaneous transmission of uplink PUSCH based on the terminal multi-panel, one or more of the above schemes will be supported.

In M-TRP transmission based on non-codebook and codebook in the related art, an SRS resource indicator (SRI) field in DCI indicates an SRS resource in an SRS resource set. Since R17 supports two SRS resource sets, in repeated transmission of an M-TRP PUSCH based on the non-codebook, DCI format 0_1/0_2 includes two SRI fields associated with the two SRS resource sets, each SRI field indicates an SRI for a TRP, the design of the first SRI field is based on an R15/16 framework, and all repeated transmissions use the same number of layers.

For non-codebook-based transmission, the first SRI field is used for determining elements in the second SRI field, and the second SRI field merely includes a SRI combination associated with the number of layers indicated by the first SRI field. A number of bits N2 in the second SRI field is determined by a maximum number of codepoints in each rank associated with the first SRI field.

In the repeated transmission of the M-TRP PUSCH based on the codebook, DCI format 0_1/0_2 indicates two TPMI fields, where the first TPMI field is designed the same as the TPMI field in R15/16 (including TPMI index and the number of layers), and the second TPMI field merely includes the second TPMI index, with the same number of layers as that indicated by the first TPMI field [15]. The first TPMI field is used for determining elements in the second TPMI field, and the second TPMI field merely includes TPMI associated with the number of layers indicated by the first TPMI field. A number of bits M2 in the second TPMI field is determined by a maximum number of codepoints in each rank associated with the first TPMI field.

The indication field for dynamically indicating S-TRP and M-TRP transmission scheduling is defined in Table 17:

TABLE 17

| | | SRI field (codebook-based or non- |
|---|---|---|
| | | codebook-based transmission)/TPMI |
| Codepoint | SRS resource set | field (codebook-based transmission) |
| 00 | S-TRP transmission mode, | First SRI/TPMI field |
| | configuring a first SRS resource set | |
| | (first TRP) | |
| 01 | S-TRP transmission mode, | First SRI/TPMI field |
| | configuring a second SRS resource | |
| | set (second TRP) | |
| 10 | M-TRP transmission mode | First and second SRI/TPMI fields |
| | (in an order of TRP1 and TRP2) | |
| | the first SRI/TPMI field corresponds | |
| | to the first SRS resource set | |
| | the second SRI/TPMI field | |
| | corresponds to the second SRS | |
| | resource set | |
| 11 | M-TRP transmission mode | First and second SRI/TPMI fields |
| | (in an order of TRP2 and TRP1) | |
| | the first SRI/TPMI field corresponds | |
| | to the first SRS resource set | |
| | the second SRI/TPMI field | |
| | corresponds to the second SRS | |
| | resource set | |

In the M-TRP uplink PUSCH enhancement of the related art, a time-division transmission scheme in a time-division multiplexing (TDM) manner in which the terminal under S-DCI scheduling uses different beams, i.e., corresponding transmission configuration indication (TCI) states, towards different TRP sending directions to perform repetition transmission of the PUSCH is supported.

Thus, in order to support the uplink simultaneous transmission scheme via the multi-panel based on the S-DCI, the present disclosure needs to consider an enhanced scheme for flexible allocation indication of DMRS ports that can support SU-MIMO and MU-MIMO under the SDM transmission multiplexing scheme.

FIG. 4 is a flowchart of a method for indicating an uplink DMRS port shown according to an example. As shown in FIG. 4, the method for indicating the uplink DMRS port is used in a network device, and includes the following steps.

In step S11, first indication information is sent in a case where a terminal performs S-DCI based STxMP of a PUSCH in an SDM manner.

A DMRS indication field in DCI is configured to indicate a total number of all allocated DMRS ports for the terminal. The first indication information is configured to indicate a DMRS port that is respectively allocated when a transport block of the PUSCH is sent over a same time-frequency resource towards a different TRP via a different panel, where a different TRP/panel/TCI/TO is respectively associated with a different beam/TCI, and a correspondence relationship exists between the DMR ports and a panel.

In the embodiment of the present disclosure: the first indication information is sent by the network device to the terminal in a case where the terminal performs the S-DCI based STxMP of the PUSCH in the SDM manner. Because the indication field of the antenna port DMRS in the DCI is configured to indicate a total number of all allocated DMRS ports for the terminal, the first indication information is configured to indicate the DMRS port that is respectively allocated when the transport block of the PUSCH is sent over the same time-frequency resource towards the different TRP via the different panel, where the different TRP/panel/TCI/TO is respectively associated with the different beam/TCI, and the correspondence relationship exists between the DMRS port and the panel, the terminal may obtain a different DMRS port corresponding to multi-panel transmission under the S-DCI through the first indication information.

In the method for indicating the uplink DMRS port provided by the embodiment of the present disclosure, a correspondence relationship exists between the total number of all the DMRS ports allocated by the terminal and the number of transmission layers.

For example, in a case where the total number of the DMRS ports indicated by the antenna port in the DCI is 3, it corresponds to transmission with the number of transmission layers being 3 under the SDM manner.

In the method for indicating the uplink DMRS port provided by the embodiment of the present disclosure, the first indication information is configured to indicate a correspondence relationship between a number of transmission layers used for PUSCH transmission via the different TRP/panel/TCI/TO and the DMRS port.

In the method for indicating the uplink DMRS port provided by the embodiment of the present disclosure, the first indication information is carried on the S-DCI.

An SRS resource set indicator field in a DCI signaling based on S-DCI scheduling is configured to indicate a correspondence relationship between the number of transmission layers respectively used for the PUSCH transmission on the different panel and the DMRS port.

In the method for indicating the uplink DMRS port provided by the embodiment of the present disclosure, the SRS resource set indicator field includes a redefined codepoint or a newly-added reserved codepoint.

The redefined codepoint or the newly-added reserved codepoint is configured to indicate the number of transmission layers and a combination of the number of transmission layers corresponding to different CWs/panels/TRPs/beams;

Further, a correspondence relationship exists among the number of transmission layers, the combination of the number of transmission layers, and the DMRS port.

In an implementation, the redefined codepoint or the newly-added codepoint included in the SRS resource set indicator field in the embodiment of the present disclosure may be obtained by redefining or newly adding based on a codepoint situation indicated in a table of a corresponding SRS resource set indicator field in a previous protocol version after updating and improving the protocol version. For example, the redefined codepoint or the newly added codepoint included in the SRS resource set indicator field in R17 may be obtained by redefining or newly adding based on the codepoint included in the SRS resource set indicator field in R16.

In the method for indicating the uplink DMRS port provided by the embodiment of the present disclosure, in a case where a maximum number of transmission layers allocated to each panel is 2 and the number of transmission layers used by different panels corresponding to the combination of the number of transmission layers are different, the SRS resource set indicator field includes the redefined codepoint.

In a case where STxMP transmission is the merely-supported RANK combination of {1+1,1+2,2+1,2+2}, 2 bits in an existing SRS resource set indicator field are used for distinguishing the combination of the number of transmission layers of different panel transmissions corresponding to RANK=3.

It is to be understood that in a case where RANK=1+1 or 2+2, there is no need to provide the codepoint in the SRS resource set indicator field to indicate the combination of the number of transmission layers of the different panel.

In some embodiments, in a case where the number of transmission layers used for the PUSCH transmission via the different TRP/Panel/TCI/TO is 2, the corresponding combination of the number of transmission layers is RANK=1+1, thus, the number of transmission layers allocated to the first panel is 1, and the corresponding DMRS port is a first DMRS port; and the number of transmission layers allocated to the second panel is 1, and the corresponding DMRS port is a second DMRS port.

In some other embodiments, in a case where the number of transmission layers used for the PUSCH transmission via the different TRP/Panel/TCI/TO is 4, the corresponding combination of the number of transmission layers is RANK=2+2, thus, the number of transmission layers allocated to the first panel is 2, and the corresponding DMRS ports are a first DMRS port and a second DMRS port; and the number of transmission layers allocated to the second panel is 2, and the corresponding DMRS port is a third DMRS port.

In the method for indicating the uplink DMRS port provided by the embodiment of the present disclosure, a different codepoint corresponds to a different combination of the number of transmission layers.

In an example, a multi-panel includes a first panel and a second panel, a codepoint includes a first codepoint and a second codepoint, and the combination of the number of transmission layers includes a combination where the number of transmission layers is 1 and 2.

In some embodiments, the first codepoint corresponds to the first combination of the number of transmission layers, where the first combination of the number of transmission layers is that the number of transmission layers allocated to the first panel is 2, and the number of transmission layers allocated to the second panel is 1; and the second codepoint corresponds to a second combination of the number of transmission layers, where the second combination of the number of transmission layers is that the number of transmission layers allocated to the first panel is 1, and the number of transmission layers allocated to the second panel is 2.

In some other embodiments, the first codepoint corresponds to the first combination of the number of transmission layers, where the first combination of the number of transmission layers is that the number of transmission layers allocated to the first panel is 1, and the number of transmission layers allocated to the second panel is 2; and the second codepoint corresponds to the second combination of the number of transmission layers, where the second combination of the number of transmission layers is that the number of transmission layers allocated to the first panel is 2, and the number of transmission layers allocated to the second panel is 1.

In the method for indicating the uplink DMRS port provided by the embodiment of the present disclosure, the first codepoint and the second codepoint are respectively configured to indicate different correspondence relationships between an SRS resource set and the SRS resource set indicator field/precoder indication field under a multi-TRP transmission mode.

In an example, as shown in Table 17 above, the first codepoint and the second codepoint may be 10 or 11 respectively.

For example, as shown in Table 18, the first codepoint is 10, the corresponding first combination of the number of transmission layers is RANK=3:2+1, that is, the number of transmission layers allocated to the first panel is 2, and the corresponding DMRS ports are the first DMRS port and the second DMRS port; and the number of transmission layers allocated to the second panel is 1, and the corresponding DMRS port is a third DMRS port. The second codepoint is 11, the corresponding second combination of the number of transmission layers is RANK=3:1+2, thus, the number of transmission layers allocated to the first panel is 1, and the corresponding DMRS port is the first DMRS port; and the number of transmission layers allocated to the second panel is 2, and the corresponding DMRS ports are the second DMRS port and the third DMRS port.

TABLE 18

| | | SRI field (codebook-based or non- |
|---|---|---|
| | | codebook-based transmission)/TPMI |
| Codepoint | SRS resource set | field (codebook-based transmission) |
| 00 | S-TRP transmission mode, | First SRI/TPMI field |
| | configuring a first SRS resource set | |
| | (first TRP) | |
| 01 | S-TRP transmission mode, | Second SRI/TPMI field |
| | configuring a second SRS resource | |
| | set (second TRP) | |
| 10 | M-TRP transmission mode | First and second SRI/TPMI fields |
| | the first SRI/TPMI field | RANK = 3: 1 + 2 |
| | corresponds to the first SRS | |
| | resource set | |
| | the second SRI/TPMI field | |
| | corresponds to the second SRS | |
| | resource set | |
| 11 | M-TRP transmission mode | First and second SRI/TPMI fields |
| | the first SRI/TPMI field | RANK = 3: 2 + 1 |
| | corresponds to the first SRS | |
| | resource set | |
| | the second SRI/TPMI field | |
| | corresponds to the second SRS | |
| | resource set | |

For another example, as shown in Table 19, the first codepoint is 10, the corresponding first combination of the number of transmission layers is RANK=3:1+2, that is, the number of transmission layers allocated to the first panel is 1, and the corresponding DMRS port is the first DMRS port; the number of transmission layers allocated to the second panel is 2, and the corresponding DMRS ports are the second DMRS port and the third DMRS port. The second codepoint is 11, the corresponding second combination of the number of transmission layers is RANK=3:2+1, that is, the number of transmission layers allocated to the first panel is 2, and the corresponding DMRS ports are the first DMRS port and the second DMRS port; and the number of transmission layers allocated to the second panel is 1, and the corresponding DMRS port is the third DMRS port.

TABLE 19

| | | SRI field (codebook-based or non- |
|---|---|---|
| | | codebook-based transmission)/TPMI |
| Codepoint | SRS resource set | field (codebook-based transmission) |
| 00 | S-TRP transmission mode, | First SRI/TPMI field |
| | configuring a first SRS resource set | |
| | (first TRP) | |
| 01 | S-TRP transmission mode, | Second SRI/TPMI field |
| | configuring a second SRS resource | |
| | set (second TRP) | |
| 10 | M-TRP transmission mode | First and second SRI/TPMI fields |
| | the first SRI/TPMI field | RANK = 3: 2 + 1 |
| | corresponds to the first SRS | |
| | resource set | |
| | the second SRI/TPMI field | |
| | corresponds to the second SRS | |
| | resource set | |
| 11 | M-TRP transmission mode | First and second SRI/TPMI fields |
| | the first SRI/TPMI field | RANK = 3: 1 + 2 |
| | corresponds to the first SRS | |
| | resource set | |
| | the second SRI/TPMI field | |
| | corresponds to the second SRS | |
| | resource set | |

It is worth noting that, in addition to the implementation of allocating the DMRS port to each panel involved in the above embodiments, the DMRS port allocated to each panel may further be respectively determined by using a predefined manner, which is not limited in the embodiment of the present disclosure.

In the embodiment of the present disclosure, in a case where the maximum number of transmission layers allocated to each panel is 2, the correspondence relationship between the DMRS port and the panel is indicated by the redefined codepoint in the SRS resource set indicator field, thus, for the allocation of uplink DMRS port, the DMRS port towards the different TRP can be allocated within a same CDM group or from a different CDM group. At the same time, the RANK combination supported by a different codeword is also different, and indication of the different DMRS port corresponding to multi-panel transmission based on S-DCI can be achieved without increasing the existing protocol overhead.

In the method for indicating the uplink DMRS port provided by the embodiment of the present disclosure, in a case where the maximum number of transmission layers allocated to each panel is 3, the SRS resource set indicator field includes the newly-added reserved codepoint.

In a case where the RANK combination supported by STxMP transmission includes {1+1, 1+2, 2+1, 1+3, 3+1, 2+2}, the number of bits in the existing SRS resource set indicator field needs to be spread, that is, the reserved codepoint is newly added in the SRS resource set indicator field.

It is worth noting that in a case where the RANK combination is 1+1, there is no need to indicate the correspondence relationship between the DMRS port and the panel through newly-added reserved codepoint.

As an illustration, in a case where the RANK combination is 1+1, the number of transmission layers allocated to the first panel is 1, and the corresponding DMRS port is the first DMRS port; and the number of transmission layers allocated to the second panel is 1, and the corresponding DMRS port is the second DMRS port.

In the method for indicating the uplink DMRS port provided by the embodiment of the present disclosure, a predefined correspondence relationship exists among each of the number of transmission layers included in the combination of the number of transmission layers, the panel, and the DMRS port.

The different number of transmission layers corresponds to the different panel, and the different panel correspond to the different DMRS port.

In an example, the SRS resource set indicator field is as shown in Table 20, where 4-7 are newly-added codepoints.

TABLE 20

| | | SRI field (codebook-based or non- |
|---|---|---|
| | | codebook-based transmission)/TPMI |
| Codepoint | SRS resource set | field (codebook-based transmission) |
| 0 | S-TRP transmission mode, | First SRI/TPMI field |
| | configuring a first SRS resource set | |
| | (first TRP) | |
| 1 | S-TRP transmission mode, | Second SRI/TPMI field |
| | configuring a second SRS resource set | |
| | (second TRP) | |
| 2 | M-TRP transmission mode the | First and second SRI/TPMI fields |
| | first SRI/TPMI field corresponds to | RANK = 3: 2 + 1 |
| | the first SRS resource set | |
| | the second SRI/TPMI field | |
| | corresponds to the second SRS | |
| | resource set | |
| 3 | M-TRP transmission mode the | First and second SRI/TPMI fields |
| | first SRI/TPMI field corresponds to | RANK = 3: 1 + 2 |
| | the first SRS resource set | |
| | the second SRI/TPMI field | |
| | corresponds to the second SRS | |
| | resource set | |
| 4 | M-TRP transmission mode the | First and second SRI/TPMI fields |
| | first SRI/TPMI field corresponds to | RANK = 4: 1 + 3 |
| | the first SRS resource set | |
| | the second SRI/TPMI field | |
| | corresponds to the second SRS | |
| | resource set | |
| 5 | M-TRP transmission mode the | First and second SRI/TPMI fields |
| | first SRI/TPMI field corresponds to | RANK = 4: 2 + 2 |
| | the first SRS resource set | |
| | the second SRI/TPMI field | |
| | corresponds to the second SRS | |
| | resource set | |
| 6 | M-TRP transmission mode the | First and second SRI/TPMI fields |
| | first SRI/TPMI field corresponds to | RANK = 4: 3 + 1 |
| | the first SRS resource set | |
| | the second SRI/TPMI field | |
| | corresponds to the second SRS | |
| | resource set | |
| 7 | Reserved | Reserved |

For example, in a case where the total number of all the DMRS ports allocated and indicated by the DMRS indication field in the DCI is 4 {0, 1, 2, 3}, then the number of transmission layers is 4. In a case where the codepoint included in the SRS resource set indicator field is 4, then the corresponding RANK combination is 1+3, that is, the number of transmission layers allocated in the first panel direction is 1 and the DMRS port is {0}, and the number of transmission layers allocated in the second panel direction is 3 and the DMRS port is {1, 2, 3}.

In the embodiment of the present disclosure, in a case where the maximum number of transmission layers allocated to each panel is 3, the correspondence relationship between the DMRS port and the panel is indicated by the newly-added reserved codepoint in the SRS resource set indicator field, thus, for the allocation of uplink DMRS ports, the DMRS port towards the different TRP can be allocated within the same CDM group or from the different CDM group. At the same time, the RANK combination supported by the different codeword is also different, and indication of the different DMRS port corresponding to multi-panel transmission based on S-DCI can be achieved without increasing the existing protocol overhead.

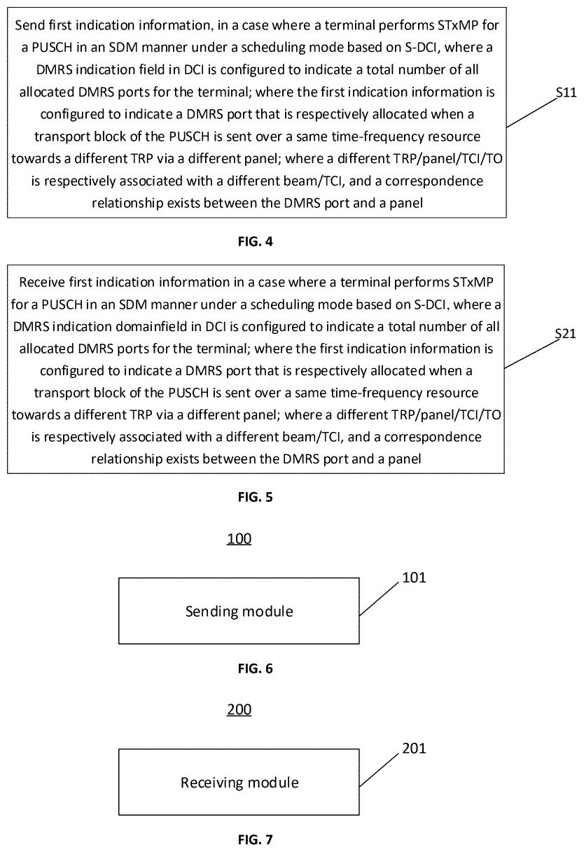

FIG. 5 is a flowchart of a method for indicating an uplink DMRS port shown according to an example. As shown in FIG. 5, the method for indicating the uplink DMRS port is used in a terminal, and includes the following steps.

In step S21, first indication information is received in a case where the terminal performs S-DCI based STxMP of a PUSCH in an SDM manner.

A DMRS indication field in DCI is configured to indicate a total number of all allocated DMRS ports for the terminal.

The first indication information is configured to indicate the DMRS port that is respectively allocated when the transport block of the PUSCH is sent over the same time-frequency resource towards the different TRP via the different panel, where the different TRP/panel/TCI/TO is respectively associated with the different beam/TCI, and the correspondence relationship exists between the DMRS port and the panel.

The terminal determines, according to received first indication information, the DMRS port that is respectively allocated when the transport block of the PUSCH is sent over the same time-frequency resource towards the different TRP via the different panel, where the different TRP/panel/TCI/TO is respectively associated with the different beam/TCI, and the correspondence relationship exists between the DMRS port and the panel.

In the embodiment of the present disclosure: the first indication information sent by the network device is received by the terminal in a case where the terminal performs the S-DCI based STxMP of the PUSCH in the SDM manner. Because the indication field of the antenna port DMRS in the DCI is configured to indicate the total number of all allocated DMRS ports for the terminal, the first indication information is configured to indicate the DMRS port that is respectively allocated when the transport block of the PUSCH is sent over the same time-frequency resource towards the different TRP via the different panel, where the different TRP/panel/TCI/TO is respectively associated with the different beam/TCI, and the correspondence relationship exists between the DMRS port and the panel, the terminal may obtain the different DMRS port corresponding to multi-panel transmission under the S-DCI through the first indication information.

In the method for indicating the uplink DMRS port provided by the embodiment of the present disclosure, a correspondence relationship exists between the total number of all the DMRS ports allocated by the terminal and the number of transmission layers.

For example, in a case where the total number of the DMRS ports indicated by the antenna port in the DCI is 3, it corresponds to transmission with the number of transmission layers being 3 under the SDM manner.

In the method for indicating the uplink DMRS port provided by the embodiment of the present disclosure, the first indication information is configured to indicate a correspondence relationship between the number of transmission layers used for PUSCH transmission via the different TRP/panel/TCI/TO and the DMRS port.

In the method for indicating the uplink DMRS port provided by the embodiment of the present disclosure, the first indication information is carried on the S-DCI.

An SRS resource set indicator field in a DCI signaling based on S-DCI scheduling is configured to indicate a correspondence relationship between the number of transmission layers respectively used for the PUSCH transmission on the different panel and the DMRS port.

In the method for indicating the uplink DMRS port provided by the embodiment of the present disclosure, the SRS resource set indicator field includes a redefined codepoint or a newly-added reserved codepoint.

The redefined codepoint or the newly-added reserved codepoint is configured to indicate the number of transmission layers and a combination of the number of transmission layers corresponding to different CWs/panels/TRPs/beams;

Further, a correspondence relationship exists among the number of transmission layers, the combination of the number of transmission layers, and the DMRS port.

In the method for indicating the uplink DMRS port provided by the embodiment of the present disclosure, in a case where the maximum number of transmission layers allocated to each panel is 2 and the number of transmission layers used by different panels corresponding to the combination of the number of transmission layers are different, the SRS resource set indicator field includes the redefined codepoint.

In a case where STxMP transmission is the merely-supported RANK combination of {1+1,1+2,2+1,2+2}, 2 bits in the existing SRS resource set indicator field are used for distinguishing the combination of the number of transmission layers of different panel transmissions corresponding to RANK=3.

It is to be understood that in a case where RANK=1+1 or 2+2, there is no need to provide the codepoint in the SRS resource set indicator field to indicate the combinations of the number of transmission layers of the different panel.

In some embodiments, in a case where the number of transmission layers used for the PUSCH transmission via the different TRP/Panel/TCI/TO is 2, the corresponding combination of the number of transmission layers is RANK=1+1, thus, the number of transmission layers allocated to the first panel is 1, and the corresponding DMRS port is a first DMRS port; and the number of transmission layers allocated to the second panel is 1, and the corresponding DMRS port is a second DMRS port.

In some other embodiments, in a case where the number of transmission layers used for the PUSCH transmission via the different TRP/Panel/TCI/TO is 4, the corresponding combination of the number of transmission layers is RANK=2+2, thus, the number of transmission layers allocated to the first panel is 2, and the corresponding DMRS ports are a first DMRS port and a second DMRS port; and the number of transmission layers allocated to the second panel is 2, and the corresponding DMRS port is a third DMRS port.

In the method for indicating the uplink DMRS port provided by the embodiment of the present disclosure, the different codepoint corresponds to the different combination of the number of transmission layers.

In an example, a multi-panel includes a first panel and a second panel, the codepoint includes a first codepoint and a second codepoint, and the combination of the number of transmission layers includes a combination where the number of transmission layers is 1 and 2.

In some embodiments, the first codepoint corresponds to the first combination of the number of transmission layers, where the first combination of the number of transmission layers is that the number of transmission layers allocated to the first panel is 2, and the number of transmission layers allocated to the second panel is 1; and the second codepoint corresponds to a second combination of the number of transmission layers, where the second combination of the number of transmission layers is that the number of transmission layers allocated to the first panel is 1, and the number of transmission layers allocated to the second panel is 2.

In some other embodiments, the first codepoint corresponds to the first combination of the number of transmission layers, where the first combination of the number of transmission layers is that the number of transmission layers allocated to the first panel is 1, and the number of transmission layers allocated to the second panel is 2; and the second codepoint corresponds to the second combination of the number of transmission layers, where the second combination of the number of transmission layers is that the number of transmission layers allocated to the first panel is 2, and the number of transmission layers allocated to the second panel is 1.

In the method for indicating the uplink DMRS port provided by the embodiment of the present disclosure, the first codepoint and the second codepoint are respectively configured to indicate different correspondence relationships between the SRS resource set and the SRS resource set indicator field/precoder indication field under the multi-TRP transmission mode.

In an example, as shown in Table 17 above, the first codepoint and the second codepoint may be 10 or 11 respectively.

For example, as shown in Table 18 above, the first codepoint is 10, the corresponding first combination of the number of transmission layers is RANK=3:2+1, that is, the number of transmission layers allocated to the first panel is 2, and the corresponding DMRS ports are the first DMRS port and the second DMRS port; the number of transmission layers allocated to the second panel is 1, and the corresponding DMRS port is a third DMRS port. The second codepoint is 11, the corresponding second combination of the number of transmission layers is RANK=3:1+2, thus, the number of transmission layers allocated to the first panel is 1, and the corresponding DMRS port is the first DMRS port; and the number of transmission layers allocated to the second panel is 2, and the corresponding DMRS ports are the second DMRS port and the third DMRS port.

For another example, as shown in Table 19 above, the first codepoint is 10, the corresponding first combination of the number of transmission layers is RANK=3:1+2, that is, the number of transmission layers allocated to the first panel is 1, and the corresponding DMRS port is the first DMRS port; the number of transmission layers allocated to the second panel is 2, and the corresponding DMRS ports are the second DMRS port and the third DMRS port. The second codepoint is 11, the corresponding second combination of the number of transmission layers is RANK=3:2+1, that is, the number of transmission layers allocated to the first panel is 2, and the corresponding DMRS ports are the first DMRS port and the second DMRS port; and the number of transmission layers allocated to the second panel is 1, and the corresponding DMRS port is the third DMRS port.

It is worth noting that, in addition to the implementation of allocating the DMRS port to each panel involved in the above embodiments, the DMRS port allocated to each panel may further be respectively determined by using a predefined manner, which is not limited in the embodiment of the present disclosure.

In the embodiment of the present disclosure, in a case where the maximum number of transmission layers allocated to each panel is 2, the correspondence relationship between the DMRS port and the panel is indicated by the redefined codepoint in the SRS resource set indicator field, thus, for the allocation of uplink DMRS ports, the DMRS port towards the different TRP can be allocated within the same CDM group or from the different CDM group. At the same time, the RANK combination supported by the different codeword is also different, and indication of the different DMRS port corresponding to multi-panel transmission based on S-DCI can be achieved without increasing the existing protocol overhead.

In the method for indicating the uplink DMRS port provided by the embodiment of the present disclosure, in a case where the maximum number of transmission layers allocated to each panel is 3, the SRS resource set indicator field includes the newly-added reserved codepoint.

In a case where the RANK combination supported by STxMP transmission includes {1+1, 1+2, 2+1, 1+3, 3+1, 2+2}, the number of bits in the existing SRS resource set indicator field needs to be spread, that is, the reserved codepoint is newly added in the SRS resource set indicator field.

It is worth noting that in a case where the RANK combination is 1+1, there is no need to indicate the correspondence relationship between the DMRS ports and the panel through newly-added reserved codepoint.

As an illustration, in a case where the RANK combination is 1+1, the number of transmission layers allocated to the first panel is 1, and the corresponding DMRS port is the first DMRS port; and the number of transmission layers allocated to the second panel is 1, and the corresponding DMRS port is the second DMRS port.

In the method for indicating the uplink DMRS port provided by the embodiment of the present disclosure, a predefined correspondence relationship exists among each of the number of transmission layers included in the combination of the number of transmission layers, the panel, and the DMRS port.

The different number of transmission layers corresponds to the different panel, and the different panel corresponds to the different DMRS port.

In an example, the SRS resource set indicator field is as shown in Table 20 above, where 4-7 are newly-added codepoints.

For example, in a case where the total number of all the DMRS ports allocated and indicated by the DMRS indication field in the DCI is 4 {0, 1, 2, 3}, then the number of transmission layers is 4. In a case where the codepoint included in the SRS resource set indicator field is 4, then the corresponding RANK combination is 1+3, that is, the number of transmission layers allocated in the first panel direction is 1 and the DMRS port is {0}, and the number of transmission layers allocated in the second panel direction is 3 and the DMRS port is {1, 2, 3}.

The method for indicating the uplink DMRS port provided by the present disclosure is applicable to a process of implementing the indication of the uplink DMRS port through the interaction between the terminal and the network device. In the method for indicating the uplink DMRS port through the interaction between the terminal and the network device, the terminal and the network device respectively have the relevant functions for implementing the method for indicating the uplink DMRS port mentioned in the above embodiments, which will not be repeated here.

In the embodiment of the present disclosure, in a case where the maximum number of transmission layers allocated to each panel is 3, the correspondence relationship between the DMRS port and the panel is indicated by the newly-added reserved codepoint in the SRS resource set indicator field, thus, for the allocation of uplink DMRS ports, the DMRS port towards the different TRP can be allocated within the same CDM group or from the different CDM group. At the same time, the RANK combination supported by the different codeword is also different, and indication of the different DMRS port corresponding to multi-panel transmission based on S-DCI can be achieved without increasing the existing protocol overhead.

It is to be noted that those skilled in the art can understand that the various above-mentioned implementations/embodiments of the embodiments of the present disclosure can be used in conjunction with the aforementioned embodiments or independently. Whether to be used alone or together with the aforementioned embodiments, its implementation principle is similar. In the embodiment of the present disclosure, some embodiments are illustrated through the implementation used together. Certainly, those skilled in the art can understand that such examples do not limit the embodiments of the present disclosure.

Based on the same concept, an embodiment of the present disclosure further provides a device for indicating an uplink DMRS port.

It may be understood that, in order to implement the above functions, the device for indicating the uplink DMRS port provided by the embodiment of the present disclosure includes corresponding hardware structures and/or software modules for performing all the functions. In combination with units and algorithm steps of each example disclosed in the embodiment of the present disclosure, the embodiment of the present disclosure can be implemented in a form of hardware or a combination of hardware and computer software. Whether a certain function is performed in a mode of hardware or a mode of the hardware driven by the computer software depends on a specific application and design constraint conditions of the technical solution. Those skilled in the art may use different methods to implement the described functions for each specific application, but such implementation does not need to be regarded beyond the scope of the technical solution of the embodiment of the present disclosure.

FIG. 6 is a block diagram of a device for indicating an uplink DMRS port shown according to an example. Referring to FIG. 6, the device includes a sending module 101. The device 100 for indicating the uplink DMRS port may be applied to a network device.

The sending module 101 is configured to send first indication information, in a case where a terminal performs S-DCI based STxMP of a PUSCH in an SDM manner. A DMRS indication field in DCI is configured to indicate a total number of all allocated DMRS ports for the terminal. The first indication information is configured to indicate the DMRS port that is respectively allocated when the transport block of the PUSCH is sent over the same time-frequency resource towards the different transmission and reception point (TRP) via the different panel, where the different TRP/panel/TCI/TO is respectively associated with the different beam/TCI, and the correspondence relationship exists between the DMRS port and the panel.

In an implementation, the first indication information is configured to indicate a correspondence relationship between the number of transmission layers used for PUSCH transmission via the different panel/TRP/TCI/TO and the DMRS port.

In an implementation, the first indication information is carried on the S-DCI; and
an SRS resource set indicator field in a DCI signaling based on S-DCI scheduling is configured to indicate a correspondence between the number of transmission layers respectively used for the PUSCH transmission via the different panel and the DMRS port.

In an implementation, the SRS resource set indicator field includes a redefined codepoint or a newly-added reserved codepoint; and
the redefined codepoint or the newly-added reserved codepoint is configured to indicate the number of transmission layers and a combination of the number of transmission layers corresponding to different CWs/panels/TRPs/beams;
where a correspondence relationship exists among the number of transmission layers, the combination of the number of transmission layers, and the DMRS port.

In an implementation, in a case where the maximum number of transmission layers allocated to each panel is 2 and the number of transmission layers used by different panels corresponding to the combination of the number of transmission layers are different, the SRS resource set indicator field includes the redefined codepoint.

In an implementation, the different codepoint corresponds to the different combination of the number of transmission layers.

In an implementation, a multi-panel includes a first panel and a second panel, the codepoint includes a first codepoint and a second codepoint, and the combination of the number of transmission layers includes a combination where the number of transmission layers is 1 and 2;
where the different codepoints corresponds to the different combination of the number of transmission layers includes:
the first codepoint corresponds to a first combination of the number of transmission layers, where the first combination of the number of transmission layers is that the number of transmission layers allocated to the first panel is 2, and the number of transmission layers allocated to the second panel is 1; and
the second codepoint corresponds to a second combination of the number of transmission layers, where the second combination of the number of transmission layers is that the number of transmission layers allocated to the first panel is 1, and the number of transmission layers allocated to the second panel is 2;
or,
the first codepoint corresponds to the first combination of the number of transmission layers, where the first combination of the number of transmission layers is that the number of transmission layers allocated to the first panel is 1, and the number of transmission layers allocated to the second panel is 2; and
the second codepoint corresponds to the second combination of the number of transmission layers, where the second combination of the number of transmission layers is that the number of transmission layers allocated to the first panel is 2, and the number of transmission layers allocated to the second panel is 1.

In an implementation, the first codepoint and the second codepoint are respectively configured to indicate different correspondence relationships between the SRS resource set and the SRS resource set indicator field/precoder indication field under a multi-TRP transmission mode.

In an implementation, in a case where the maximum number of transmission layers allocated to each panel is 3, the SRS resource set indicator field includes the newly-added reserved codepoint.

In an implementation, a predefined correspondence relationship exists among each of the number of transmission layers included in the combination of the number of transmission layers, the panel, and the DMRS port;
where the different number of transmission layers corresponds to the different panel, and the different panel corresponds to the different DMRS port.

FIG. 7 is a block diagram of a device for indicating an uplink DMRS port shown according to an example. Referring to FIG. 7, the device includes a receiving module 201. The device 200 for indicating the uplink DMRS port may be applied to a terminal.

The receiving module 201 is configured to send first indication information, in a case where a terminal performs S-DCI based STxMP of a PUSCH in an SDM manner. A DMRS indication field in DCI is configured to indicate a total number of all allocated DMRS ports for the terminal. The first indication information is configured to indicate the DMRS port that is respectively allocated when the transport block of the PUSCH is sent over the same time-frequency resource towards the different transmission and reception point (TRP) via the different panel, where the different TRP/panel/TCI/TO is respectively associated with the different beam/TCI, and the correspondence relationship exists between the DMRS port and the panel.

In an implementation, the first indication information is configured to indicate a correspondence relationship between the number of transmission layers used for PUSCH transmission via the different TRP/panel/TCI/TO and the DMRS port.

In an implementation, the first indication information is carried on single downlink control information (S-DCI); and
an SRS resource set indicator field in a DCI signaling based on S-DCI scheduling is configured to indicate a correspondence relationship between the number of transmission layers respectively used for the PUSCH transmission via the different panel and the DMRS port.

In an implementation, the SRS resource set indicator field includes a redefined codepoint or a newly-added reserved codepoint; and
the redefined codepoint or the newly-added reserved codepoint is configured to indicate the number of transmission layers and a combination of the number of transmission layers corresponding to different CWs/panels/TRPs/beams;
where a correspondence relationship exists among the number of transmission layers, the combination of the number of transmission layers, and the DMRS port.

In an implementation, in a case where the maximum number of transmission layers allocated to each panel is 2 and the number of transmission layers used by different panels corresponding to the combination of the number of transmission layers are different, the SRS resource set indicator field includes the redefined codepoint.

In an implementation, the different codepoint corresponds to the different combination of the number of transmission layers.

In an implementation, a multi-panel includes a first panel and a second panel, the codepoint includes a first codepoint and a second codepoint, and the combination of the number of transmission layers includes a combination where the number of transmission layers is 1 and 2; and
the different codepoints corresponds to the different combinations of the number of transmission layers includes:
the first codepoint corresponds to a first combination of the number of transmission layers, where the first combination of the number of transmission layers is that the number of transmission layers allocated to the first panel is 2, and the number of transmission layers allocated to the second panel is 1; and
the second codepoint corresponds to a second combination of the number of transmission layers, where the second combination of the number of transmission layers is that the number of transmission layers allocated to the first panel is 1, and the number of transmission layers allocated to the second panel is 2;
or,
the first codepoint corresponds to the first combination of the number of transmission layers, where the first combination of the number of transmission layers is that the number of transmission layers allocated to the first panel is 1, and the number of transmission layers allocated to the second panel is 2; and
the second codepoint corresponds to the second combination of the number of transmission layers, where the second combination of the number of transmission layers is that the number of transmission layers allocated to the first panel is 2, and the number of transmission layers allocated to the second panel is 1.

In an implementation, the first codepoint and the second codepoint are respectively configured to indicate different correspondence relationships between an SRS resource set and the SRS resource set indicator field/precoder indication field under a multi-TRP transmission mode.

In an implementation, in a case where the maximum number of transmission layers allocated to each panel is 3, the SRS resource set indicator field includes the newly-added reserved codepoint.

In an implementation, a predefined correspondence relationship exists among each of the number of transmission layers included in the combination of the number of transmission layers, the panel, and the DMRS port;
where the different number of transmission layers corresponds to the different panel, and the different panel corresponds to the different DMRS port.

It is to be noted that various modules/units involved in the device 100 for indicating the uplink DMRS port and the device 200 for indicating the uplink DMRS port involved in the embodiment of the present disclosure are merely illustrative and are not limited to this. For example, the device 100 for indicating the uplink DMRS port in the embodiment of the present disclosure may further include a receiving unit and/or a processing unit. The device 200 for indicating the uplink DMRS port may further include a sending unit and/or a processing unit. The units included in the device 100 for indicating the uplink DMRS port and the device 200 for indicating the uplink DMRS port may interact with each other or interact with other network element devices.

As for the devices in the above embodiments, the specific manners for performing operations by each module have been described in the embodiments related to the method in detail, which is not illustrated in detail here.

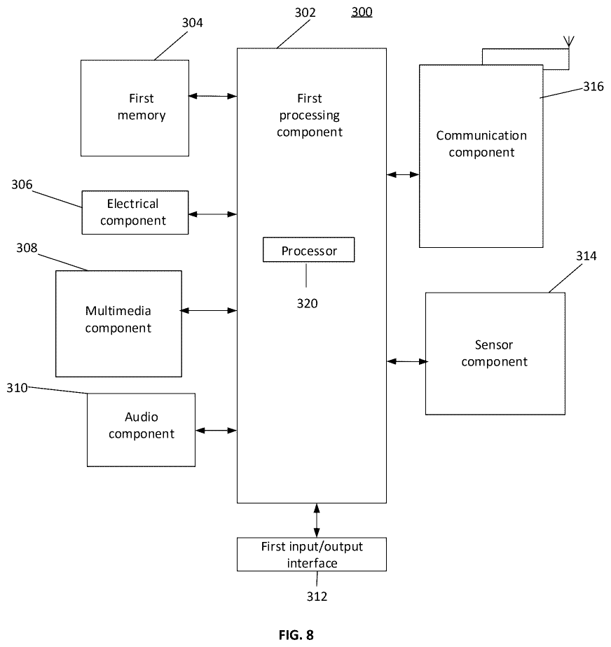

FIG. 8 is a block diagram of a device for indicating an uplink DMRS port shown according to an example. For example, the device 300 may be a mobile telephone, a computer, a digital broadcast terminal, a message transceiving device, a game console, a tablet device, a medical device, a fitness device, a personal digital assistant, and the like.

Referring to FIG. 8, the device 300 may include one or more of the following components: a first processing component 302, a first memory 304, an electrical component 306, a multimedia component 308, an audio component 310, a first input/output (I/O) interface 312, a sensor component 314, and a communication component 316.

The first processing component 302 usually controls an overall operation of the device 300, such as operations associated with displaying, telephone calling, data communication, a camera operation and a record operation. The first processing component 302 may include one or more processors 320 to execute an instruction, so as to complete all or part of steps of the above method. In addition, the first processing component 302 may include one or more modules, so as to facilitate interaction between the first processing component 302 and other components. For example, the first processing component 302 may include a multimedia module, so as to facilitate interaction between the multimedia component 308 and the first processing component 302.

The first memory 304 is configured to store various types of data so as to support operations on the device 300. Examples of these data include instructions of any application program or method used to be operated on the device 300, contact data, telephone directory data, messages, pictures, videos, and the like. The first memory 304 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The electrical component 306 provides electric power for various components of the device 300. The electrical component 306 may include a power management system, one or more power sources, and other components associated with generating, managing and distributing electric power for the device 300.

The multimedia component 308 includes a screen providing an output interface between the device 300 and a user. In some embodiments, the screen may include a liquid crystal display (LCD) and a touch panel (TP). In a case where the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some embodiments, the multimedia component 308 includes a front camera and/or a back camera. In a case where the device 300 is in an operation mode, such as a shooting mode or a video mode, the front camera and/or the back camera may receive external multimedia data. Each front camera and each back camera may be a fixed optical lens system or have a focal length and optical zooming capability.

The audio component 310 is configured to output and/or input an audio signal. For example, the audio component 310 includes a microphone (MIC). When the device 300 is in an operation mode, such as a call mode, a recording mode or a speech recognition mode, the microphone is configured to receive an external audio signal. The received audio signal may be further stored in the first memory 304 or sent via the communication component 316. In some embodiments, the audio component 310 further includes a speaker for outputting the audio signal.

The first I/O interface 312 provides an interface between the first processing component 302 and a peripheral interface module, and the above peripheral interface module may be a keyboard, a click wheel, buttons, etc. These buttons may include but are not limited to: a home button, a volume button, a start button and a lock button.

The sensor component 314 includes one or more sensors for providing state evaluations of all aspects for the device 300. For example, the sensor component 314 may detect an on/off state of the device 300 and relative positioning of components, for example, the components are a display and a keypad of the device 300. The sensor component 314 may further detect location change of the device 300 or one component of the device 300, whether there is contact between the user and the device 300, azimuth or speed up/speed down of the device 300, and temperature change of the device 300. The sensor component 314 may include a proximity sensor, which is configured to detect the existence of a nearby object without any physical contact. The sensor component 314 may further include an optical sensor, such as a CMOS or CCD image sensor, for use in an imaging application. In some embodiments, the sensor component 314 may further include an acceleration sensor, a gyroscope sensor, a magnetic sensor, a pressure sensor or a temperature sensor.

The communication component 316 is configured to facilitate wired or wireless communication between the device 300 and other devices. The device 300 may access a wireless network based on a communication standard, such as WiFi, 2G or 3G, or their combination. In an example, the communication component 316 receives a broadcast signal or broadcast related information from an external broadcast management system via a broadcast channel. In an example, the communication component 316 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the device 300 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-temporary computer readable storage medium including instructions is further provided, such as a first memory 304 including instructions. The above instructions may be executed by a processor 320 of a device 300 so as to complete the above method. For example, the non-temporary computer readable storage medium may be an ROM, a random access memory (RAM), a CD-ROM, a magnetic tape, a floppy disk, an optical data storage device and the like.

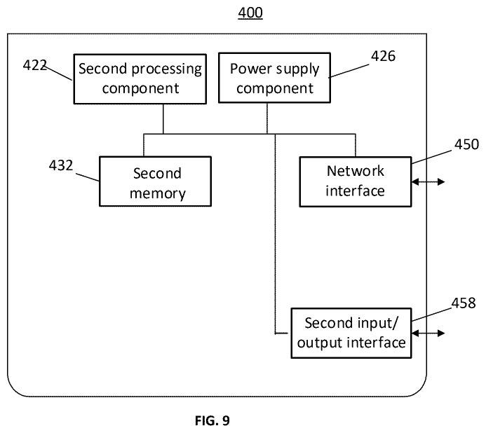

FIG. 9 is a block diagram of a device for indicating an uplink DMRS port shown according to an example. For example, the device 400 may be provided as a network device. Referring to FIG. 9, the device 400 includes a second processing component 422, which further includes one or more processors, and a memory resource represented by a second memory 432, for storing instructions executable by the second processing component 422, such as an application program. The application program stored in the second memory 432 may include one or more modules with each corresponding to a set of instructions. In addition, the second processing component 422 is configured to execute the instructions to execute the above method.

The device 400 may further include a power supply component 426 configured to execute power management of the device 400, a wired or wireless network interface 450 configured to connect the device 400 to a network, and a second input/output (I/O) interface 458. The device 400 may operate based on an operating system stored in the second memory 432, such as Windows Server™, Mac OS X™, Unix™, Linux™, FreeBSD™ or the like.

In the example, a non-temporary computer readable storage medium including instructions is further provided, such as a second memory 432 including instructions. The above instructions may be executed by the second processing component 422 of the device 400 so as to complete the above method. For example, the non-temporary computer readable storage medium may be an ROM, a random access memory (RAM), a CD-ROM, a magnetic tape, a floppy disk, an optical data storage device and the like.

As used herein, the term processor may refer to one processor that performs the defined functions or a plurality of processors that collectively perform defined functions, so that the execution of the individual defined functions may be divided amongst such processors.

It may be further understood that in the present disclosure, “a plurality of” refers to two or more than two, and other quantifiers are similar. “And/or” describes an association relationship of an association object, and represents that there may be three kinds of relationships, for example, A and/or B, may represent: A exists alone, A and B exist at the same time, and B exists alone. A character “/” generally represents that the previous and next association objects are in an “or” relationship. The singular forms “a”, “the” and “this” are intended to include the plural forms as well, unless the context clearly indicates otherwise.

It may be further understood that the terms “first”, “second” and the like are used to describe various pieces of information, but these pieces of information do not need to be limited to these terms. These terms are merely configured to distinguish the same type of information from one another, and do not imply a particular order or a level of importance. In fact, the expressions “first”, “second” and the like may be used completely interchangeably. For example, in a case of not departing from the scope of the present disclosure, first information may also be called second information, and similarly, the second information may also be called the first information.

It may be further understood that although in the embodiments of the present disclosure, the operations are described in a specific order in the accompanying drawings, it does not need to be construed as requiring that the operations are executed in the specific order shown or a serial order, or that all the operations shown are executed to obtain desired results. In a certain circumstance, multitasking and parallel processing may be advantageous.

Those of skill in the art will easily figure out other implementation solutions of the present disclosure after considering the specification and practicing the invention disclosed here. The present application intends to cover any transformation, usage or adaptive change of the present disclosure, and these transformations, usages or adaptive changes conform to a general principle of the present disclosure and include common general knowledge or conventional technical means in the technical field not disclosed by the present disclosure.

It is to be understood that the present disclosure is not limited to the exact structure that has been described above and shown in the accompanying drawings, and that various modifications and changes may be made without departing from the scope of the present disclosure. The scope of the present disclosure is limited merely by the scope of the appended claims.

1. A method for indicating an uplink demodulation reference signal (DMRS) port, performed by a network device, the method comprising:
sending first indication information, in a case where a terminal performs single downlink control information (S-DCI) based simultaneous transmission via multi-panel (STxMP) of a physical uplink shared channel (PUSCH) in a space division multiplexing (SDM) manner,
wherein an indication field of an antenna port DMRS in DCI is configured to indicate a total number of all allocated DMRS ports for the terminal;
wherein the first indication information is configured to indicate a DMRS port that is respectively allocated when a transport block of the PUSCH is sent over a same time-frequency resource towards a different transmission-reception point (TRP) via a different panel; and
wherein a different TRP/panel/transmission configuration indication (TCI)/transmission occasion (TO) is respectively associated with a different beam/TCI, and a correspondence relationship exists between the DMRS port and a panel.

2. The method according to claim 1, wherein the first indication information is configured to indicate a correspondence relationship between a number of transmission layers used for PUSCH transmission via the different TRP/panel/TCI/TO and the DMRS port.

3. The method according to claim 2, wherein the first indication information is carried on the S-DCI; and
wherein a sounding reference signal (SRS) resource set indicator field in S-DCI scheduling is configured to indicate a correspondence relationship between the number of transmission layers respectively used for the PUSCH transmission via the different panel and the DMRS port.

4. The method according to claim 3, wherein the SRS resource set indicator field comprises a redefined codepoint or a newly-added reserved codepoint;
wherein the redefined codepoint or the newly-added reserved codepoint is configured to indicate the number of transmission layers and a combination of the number of transmission layers corresponding to different codewords (CWs)/panels/TRPs/beams; and
wherein a correspondence relationship exists among the number of transmission layers, the combination of the number of transmission layers, and the DMRS port.

5. The method according to claim 4, wherein in a case where a maximum number of transmission layers allocated to each panel is 2 and the number of transmission layers used by different panels corresponding to the combination of the number of transmission layers are different, the SRS resource set indicator field comprises the redefined codepoint.

6. (canceled)

7. The method according to claim 5, wherein a multi-panel comprises a first panel and a second panel, a different codepoint comprises a first codepoint and a second codepoint, and the combination of the number of transmission layers comprises a combination where the number of transmission layers is 1 and 2; and
wherein the different codepoint corresponds to a different combination of the number of transmission layers comprises:
the first codepoint corresponds to a first combination of the number of transmission layers, wherein the first combination of the number of transmission layers is that the number of transmission layers allocated to the first panel is 2, and the number of transmission layers allocated to the second panel is 1; the second codepoint corresponds to a second combination of the number of transmission layers, wherein the second combination of the number of transmission layers is that the number of transmission layers allocated to the first panel is 1, and the number of transmission layers allocated to the second panel is 2;
or
the first codepoint corresponds to the first combination of the number of transmission layers, wherein the first combination of the number of transmission layers is that the number of transmission layers allocated to the first panel is 1, and the number of transmission layers allocated to the second panel is 2; the second codepoint corresponds to the second combination of the number of transmission layers, wherein the second combination of the number of transmission layers is that the number of transmission layers allocated to the first panel is 2, and the number of transmission layers allocated to the second panel is 1.

8. The method according to claim 7, wherein the first codepoint and the second codepoint are respectively configured to indicate different correspondence relationships between an SRS resource set and the SRS resource set indicator field/precoder indication field under a multi-TRP transmission mode.

9. The method according to claim 4, wherein in a case where a maximum number of transmission layers allocated to each panel is 3, the SRS resource set indicator field comprises the newly-added reserved codepoint.

10. The method according to claim 4, wherein a predefined correspondence relationship exists among each of the number of transmission layers, the panel, and the DMRS port; and
wherein a different number of transmission layers corresponds to the different panel, and the different panel corresponds to a different DMRS port.

11. A method for indicating an uplink demodulation reference signal (DMRS) port, performed by a terminal, the method comprising:
receiving first indication information, in a case where the terminal performs single downlink control information (S-DCI) based simultaneous transmission via multi-panel (STxMP) of a physical uplink shared channel (PUSCH) in a space division multiplexing (SDM) manner,
wherein an indication field of an antenna port DMRS in DCI is configured to indicate a total number of all allocated DMRS ports for the terminal;
wherein the first indication information is configured to indicate a DMRS port that is respectively allocated when a transport block of the PUSCH is sent over a same time-frequency resource towards a different transmission-reception point (TRP) via a different panel; and
wherein a different TRP/panel/transmission configuration indication (TCI)/transmission occasion (TO) is respectively associated with a different beam/TCI, and a correspondence relationship exists between the DMRS port and a panel.

12. The method according to claim 11, wherein the first indication information is configured to indicate a correspondence relationship between a number of transmission layers used for PUSCH transmission via the different TRP/panel/TCI/TO and the DMRS port.

13. The method according to claim 12, wherein the first indication information is carried on the S-DCI; and
wherein a sounding reference signal (SRS) resource set indicator field in S-DCI scheduling is configured to indicate a correspondence relationship between the number of transmission layers respectively used for the PUSCH transmission via the different panel and the DMRS port.

14. The method according to claim 13, wherein the SRS resource set indicator field comprises a redefined codepoint or a newly-added reserved codepoint;
wherein the redefined codepoint or the newly-added reserved codepoint is configured to indicate the number of transmission layers and a combination of the number of transmission layers corresponding to different codewords (CWs)/panels/TRPs/beams; and
wherein a correspondence relationship exists among the number of transmission layers, the combination of the number of transmission layers, and the DMRS port.

15. The method according to claim 14, wherein in a case where a maximum number of transmission layers allocated to each panel is 2 and the number of transmission layers used by different panels corresponding to the combination of the number of transmission layers are different, the SRS resource set indicator field comprises the redefined codepoint.

16. (canceled)

17. The method according to claim 15, wherein a multi-panel comprises a first panel and a second panel, a different codepoint comprises a first codepoint and a second codepoint, and the combination of the number of transmission layers comprises a combination where the number of transmission layers is 1 and 2; and
wherein the different codepoint corresponds to a different combination of the number of transmission layers comprises:
the first codepoint corresponds to a first combination of the number of transmission layers, wherein the first combination of the number of transmission layers is that the number of transmission layers allocated to the first panel is 2, and the number of transmission layers allocated to the second panel is 1; the second codepoint corresponds to a second combination of the number of transmission layers, wherein the second combination of the number of transmission layers is that the number of transmission layers allocated to the first panel is 1, and the number of transmission layers allocated to the second panel is 2;
or
the first codepoint corresponds to the first combination of the number of transmission layers, wherein the first combination of the number of transmission layers is that the number of transmission layers allocated to the first panel is 1, and the number of transmission layers allocated to the second panel is 2; the second codepoint corresponds to the second combination of the number of transmission layers, wherein the second combination of the number of transmission layers is that the number of transmission layers allocated to the first panel is 2, and the number of transmission layers allocated to the second panel is 1.

18. The method according to claim 17, wherein the first codepoint and the second codepoint are respectively configured to indicate different correspondence relationships between an SRS resource set and an SRS resource set indicator field/precoder indication field under a multi-TRP transmission mode.

19. The method according to claim 14, wherein in a case where a maximum number of transmission layers allocated to each panel is 3, the SRS resource set indicator field comprises the newly-added reserved codepoint.

20. The method according to claim 14, wherein a predefined correspondence relationship exists among each of the number of transmission layers, the panel, and the DMRS port; and
wherein a different number of transmission layers corresponds to the different panel and the different panel corresponds to a different DMRS port.

21-22. (canceled)

23. A device for indicating an uplink demodulation reference signal (DMRS) port, comprising:
one or more processors; and
a memory that stores processor-executable instructions;
wherein the one or more processors are collectively configured to perform the method according to claim 1.

24. A device for indicating an uplink demodulation reference signal (DMRS) port, comprising:
one or more processors; and
a memory that stores processor-executable instructions;
wherein the one or more processors are collectively configured to:
receive first indication information, in a case where a terminal performs single downlink control information (S-DCI) based simultaneous transmission via multi-panel (STxMP) of a physical uplink shared channel (PUSCH) in a space division multiplexing (SDM) manner,
wherein an indication field of an antenna port DMRS in DCI is configured to indicate a total number of all allocated DMRS ports for the terminal;
wherein the first indication information is configured to indicate a DMRS port that is respectively allocated when a transport block of the PUSCH is sent over a same time-frequency resource towards a different transmission-reception point (TRP) via a different panel; and
wherein a different TRP/panel/transmission configuration indication (TCI)/transmission occasion (TO) is respectively associated with a different beam/TCI, and a correspondence relationship exists between the DMRS port and a panel.

25-26. (canceled)
